(19) United States
(12) Patent Application Publication
(10) Pub. No.: US 2003/0143366 A1
(43) Pub. Date: Jul. 31, 2003

(54) Polymeric and fibrous laminate and methods of forming and using same

(76) Inventor: Jerry Foley, Tucson, AZ (US)

Correspondence Address: Jeffrey S. Whittle, P.O. Box 61389, Houston, TX, 77208-1389, US

(21) Appl. No.: 10/340,450

(22) Filed: Jan. 10, 2003

Related U.S. Application Data
(60) Provisional application No. 60/349,389, filed on Jan. 17, 2002.

(51) Int. Cl. B27N 7/00; B32B 31/04

(52) U.S. Cl. 428/67; 264/258; 264/324; 264/340

(57) ABSTRACT

A polymeric and fibrous laminate is preferably formed of a polyolefin having fillers, such as ground glass, shredded cloth, polypropylene, scrap urethane, or other materials which are heated, mixed, and made into a high viscosity gelatin mass. The polyolefin is combined with a fibrous material in the form of a veil of some type such as Trevira (or other synthetic material), glass (such as fiberglass or other mineral origin materials), or natural fibers, or combinations thereof. The laminate advantageously enhances retainment of fasteners when inserted into the laminate and superior adhesion properties to bond to other substrates that would normally not bond to recycled or virgin polyolefins.

### RELATED APPLICATIONS

This application claims the benefit of provisional application having U.S. Serial No. 60/349,389, filed on Jan. 17, 2002, which hereby is incorporated by reference in its entirety.

### BACKGROUND OF THE INVENTION

1. Field of the Invention

This invention relates to laminate products and methods and, more particularly, to a fibrous and recycled plastic laminate and methods of laminating fibrous material to a recycled plastic related laminate to enhance fastener retention qualities, physical properties and surface bonding properties.

2. Description of the Related Art

In the laminate industry, various types of plastic laminates or composites are often used in various industries such as boating, automotive, airplane, luggage, seating, construction, and other custom use applications. Plastic recycled laminates, and particularly high strength plastic recycled laminates, however, have conventionally had quite a bit of difficulty retaining fasteners such as screws, rivets, threaded eyelets, or hooks and have also had great difficulty and expense bonding to other products. The fasteners are often formed of a metal material and the smooth surfaces between the metal material and the plastic material allows the fastener to slip, slide, or detach from the plastic material.

The marine industry has historically used plywood in the construction of boats. Many disadvantages exist with the use of plywood in this industry due to the exposure of the plywood to water, such as plywood rots, delaminates, increases in weight due to absorption of water, is prone to grow fungus due to exposure to water, has a lower bonding strength to fiberglass laminates, and has poor screw retention properties. A need exists in the marine industry for a material that can replace the plywood in construction of boats that will not have the same problems experienced by plywood.

With the emphasis in recent years on reducing the amount of wastes created from manufacturing processes and on conserving natural resources, recycling of spent materials has become increasingly important. Many methods and apparatuses have been developed to produce finished products from recycled materials. These finished products are still lacking in their ability to retain fasteners and the like.

One such example of recycling materials for use in various products can be found in U.S. Pat. No. 6,132,655 issued to Ray. In Ray, expanded or foamed thermoplastic materials, such as polyethylene or polystyrene, are simultaneously agitated and compressed to form a liquid mass. The liquid mass is then immediately formed into useful products by molding, extrusion, or the like.

Another example of recycling materials for further use can be found in U.S. Pat. No. 6,110,580 issued to Gebreselassie et al. In Gebreselassie, trim components of vehicles are shredded to form a fluff, which is then combined with water and a binder reagent and then placed in a mold. The fluff solution is formed into a sheet that is subjected to compression molding at elevated temperatures to produce a finished composite trim panel.

Various methods of recycling thermoplastic materials have been developed. U.S. Pat. No. 5,534,207 issued to Burrus. Burrus describes a method of heating thermoplastic solid particles simultaneously with mixing, melting and conveying the particles into a molten mass, shaping and then cooling the molten mass, and then forming an article from the molten mass.

Another method of recycling thermoplastic materials, such as polypropylene and polyolefins, can be found in U.S. Pat. No. 5,589,260 issued to Ben Zvi et al. The Ben Zvi Patent describes a process of applying radio-frequency radiation to a mixture of cut thermoplastic waste and particulate materials to soften an outer surface of the mixture by dielectric heating, while applying pressure to the mixture to bond the mixture together by sintering. The described method can be used to form a multi-ply board with the thermoplastic waste and particulate material as one of more of the plies within the multi-ply board.

Although these prior methods and apparatuses do reduce the amount of waste generated from manufacturing processes, the finished products from these methods and apparatuses do not possess sufficient fastener retention to enable fasteners to remain securely fastened thereto or surface bonding to create other laminates. Our recycled polyolefin composite to which a non-woven, natural fiber or glass fiber material is bonded to one or all sides giving us high screw retention and various bonding substrates.

A need exists for a laminate sheet that is constructed from recycled thermoplastic materials and provides superior fastener retention properties to retain a fastener and has a bondable surface within the laminate sheet. The laminate sheet needs to be strong and be capable of being used as a layer within another type of sheet, such as a foam sheet. Another need exists for a material that can replace older used materials, such as plywood, in various constructions, such as in the marine industry, that will perform better than the existing materials. A further need exists for the methods of forming the laminate sheets to be economical and efficient.

### SUMMARY OF THE INVENTION

In view of the foregoing, an embodiment of the present invention advantageously provides a fastener retention and surface bondable laminate sheet and associated methods of forming the laminate sheet that substantially enhance the fastener retention and surface bonding properties of the laminate sheet. An embodiment of the present invention also advantageously provides a fastener retention laminate foamed sheet and associated methods of forming the laminate foamed sheet that substantially enhance the strength and fastener retention properties of the laminate foamed sheet. The sheets and associated methods readily allow laminate sheets to be formed for use in boats, trucking floors, recreational vehicles floors and side walls, housing, cabinets, ice arenas, agricultural building floors, reusable concrete forms, appliances and many other applications where high strength, fastener retention, and a bondable surface can be important. The laminate sheets and associated methods of forming the laminate sheets described herein are cost effective to produce and relatively simple to manufacture.

The laminate sheets of the present invention advantageously enhance the retainment of fasteners when inserted into the laminate sheets and a high bonding strength to the laminate. In all embodiments of the current invention, the laminate sheets, the laminate foamed sheets, and combinations of sheets and threaded fasteners have high strength and enhanced fastener retention and bonding properties so that a threaded fastener is retained within a sheet and is not easily removed when an outward force is applied thereto and other materials can bond to the surface to create other laminates.

One embodiment of the present invention preferably provides a method of forming a laminate sheet. To form the laminate sheet, a polyolefin blend is first heated thereby resulting in a gelatin mass. Next, a first bonding veil is positioned in a press, followed by the gelatin mass, and then a second bonding veil. The first and second bonding veils can be a fibrous material in the form of a veil of some type such as Trevira (or other synthetic material) or glass (such as fiberglass or other mineral origin materials). Once the materials are in the press, the gelatin mass is compressed between the first and second bonding veils to imbed the gelatin mass within the first and second bonding veils. When this occurs, the first and second bonding veils abuttingly contact and substantially adhere to the gelatin mass. The gelatin mass fills the press and penetrates a short distance into the first and second bonding veils. The gelatin mass is typically not adhesive, but the instant method enables it to adhere to materials in which it normally would not adhere. The polyolefin and the bonding veils can be rigid, i.e., sheets, or semi-rigid or flexible (a film or a roll of material).

The laminate sheet of the present invention has many uses. For example, the laminate sheet can be used as a component to form a laminate foamed sheet. The laminate sheet will increase the bonding strength of the laminate foamed sheet and increase such properties as screw retention and strength.

A method of retaining a threaded fastener within a laminate sheet is advantageously provided as another embodiment of the current invention. In this embodiment, the method preferably includes providing a laminate sheet having a density in the range of about 35 pounds per cubic foot to about 65 pounds per cubic foot and positioning a threaded fastener therein. The threaded fastener is advantageously retained within the laminate sheet and is not easily removed when an outward force is applied.

The present invention further advantageously provides a method of retaining enhanced fastener retention properties in a laminate sheet. The method includes providing a laminate sheet. The laminate sheet preferably includes a polyolefin blend and a bonding veil. A threaded fastener is then twisted into the laminate sheet, so that the fastener becomes engaged within the laminate sheet. The threaded fastener is then removed from the laminate sheet. The laminate sheet retains its enhanced fastener retention properties once the threaded fastener is removed. The laminate sheet retains its enhanced fastener retention properties even if this method is performed repeatedly upon the laminate sheet.

In addition to the method embodiments of the present invention, several other embodiments are also included. These embodiments include laminate sheets and combination fastener and laminate sheets.

The present invention advantageously provides a laminate sheet as one embodiment and also a combination fastener and laminate sheet as another embodiment. The combination preferably includes a laminate sheet and a fastener having threaded portions positioned within the laminate sheet so that the threaded portions are retained in the laminate sheet. The laminate sheet preferably includes a polyolefin blend and a bonding veil. The bonding veil preferably contacts and substantially adheres to the polyolefin blend. When constructed in this manner, the threaded fastener is not easily removed when an outward force is applied thereto.

Another laminate sheet embodiment and another combination fastener and laminate sheet embodiment are also both included as further embodiments of the present invention. In the combination embodiment, the combination preferably comprises a laminate sheet having a polyolefin blend, a glass material, and a bonding veil. In both embodiments, the laminate sheet preferably has a density in the range of about 35 pounds per cubic foot to about 65 pounds per cubic foot, and more preferably in the range of about 40 pounds per cubic foot to about 63 pounds per cubic foot. The bonding veil contacts and substantially adheres to the polyolefin blend and the glass material.

In all embodiments of the present invention that use a polyolefin, the polyolefin is preferably polyethylene, polypropylene, or any other suitable polyolefin. Such suitable alternate polyolefins will be known to those skilled in the art. One particularly effective polyolefin is a recycled polyethylene that includes a scrap polyethylene and at least one filler, such as ground glass, cellulose fibers, shredded cloth, polypropylene, scrap urethane with glass, scrap urethane without glass, and combinations thereof. As an alternate to the polyolefin in all embodiments, another non-adhesive material can be used, such as plastics, resins, a glass material, and combinations thereof. The polyolefin or the non-adhesive material is combined with a fibrous material in the form of a veil of some type such as Trevira (or other synthetic material), glass (such as fiberglass or other mineral origin materials), or natural fibers or combinations thereof.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a perspective view of a polyolefin blending process to combine the polyolefins and fillers as stated above according to an embodiment of the present invention;

FIG. 2 is a perspective view of heated polyolefin blend being poured into a sheet of material according to an embodiment of the present invention;

FIG. 3 is a perspective view of a plurality of layers of a bonding veil and a polyolefin blend being positioned in a press cavity to be pressed together to form a laminate sheet according to an embodiment of the present invention;

FIG. 4 is an environmental perspective view of a plurality of laminate sheets being subjected to cooling fans according to an embodiment of the present invention;

FIG. 5 is a schematic flow diagram of a method of forming laminate sheets according to an embodiment of the present invention;

FIG. 6 is a perspective view of a laminate sheet according to an embodiment of the present invention;

FIG. 7 is an enlarged sectional view of a laminate sheet taken along line 7-7 of FIG. 6 according to an embodiment of the present invention;

FIG. 8 is an enlarged sectional view of a laminate sheet according to an embodiment of the present invention;

FIG. 9 is a fragmentary environmental perspective view of a combination fastener and laminate sheet with the fastener being inserted into the laminate sheet according to an embodiment of the present invention;

FIG. 10 is a perspective view of a plurality of layers of a laminate sheet and a glass material being positioned in a press cavity to be pressed together according to an embodiment of the present invention;

FIG. 11 is a perspective view of a combination fastener and laminate sheet according to an embodiment of the present invention;

FIG. 12 is an enlarged sectional view of a combination fastener and laminate sheet taken along line 11-11 of FIG. 11 according to an embodiment of the present invention;

FIG. 13 is an enlarged sectional view of a combination fastener and laminate sheet with a layer of material secured between the fastener and the laminate sheet according to an embodiment of the present invention; and

FIG. 14 is a simplified block diagram for the process of making a laminate sheet of the present invention with the use of a semi-rigid or flexible polyolefin material and a semi-rigid or flexible bonding veil according to an embodiment of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art. Like numbers refer to like elements throughout, and prime, double prime, and triple prime notation, where used, generally indicate similar elements in alternative embodiments.

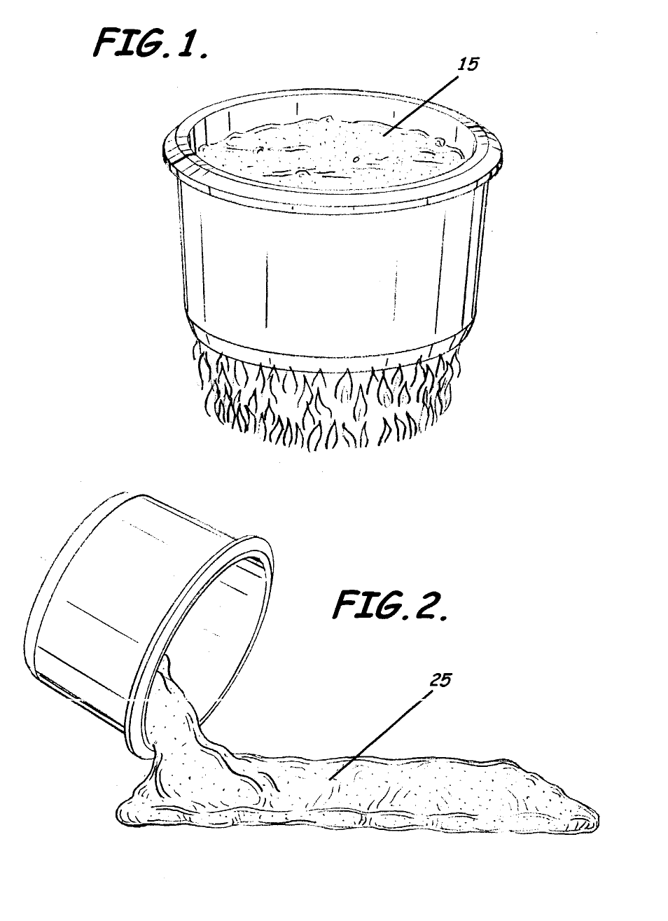

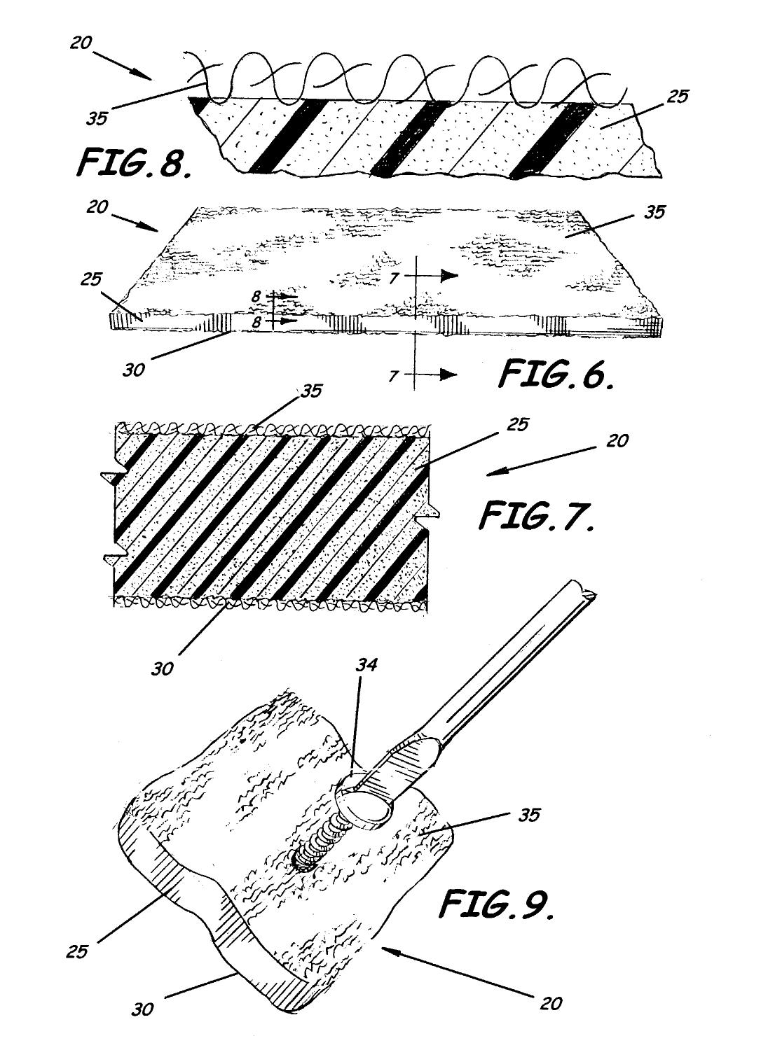

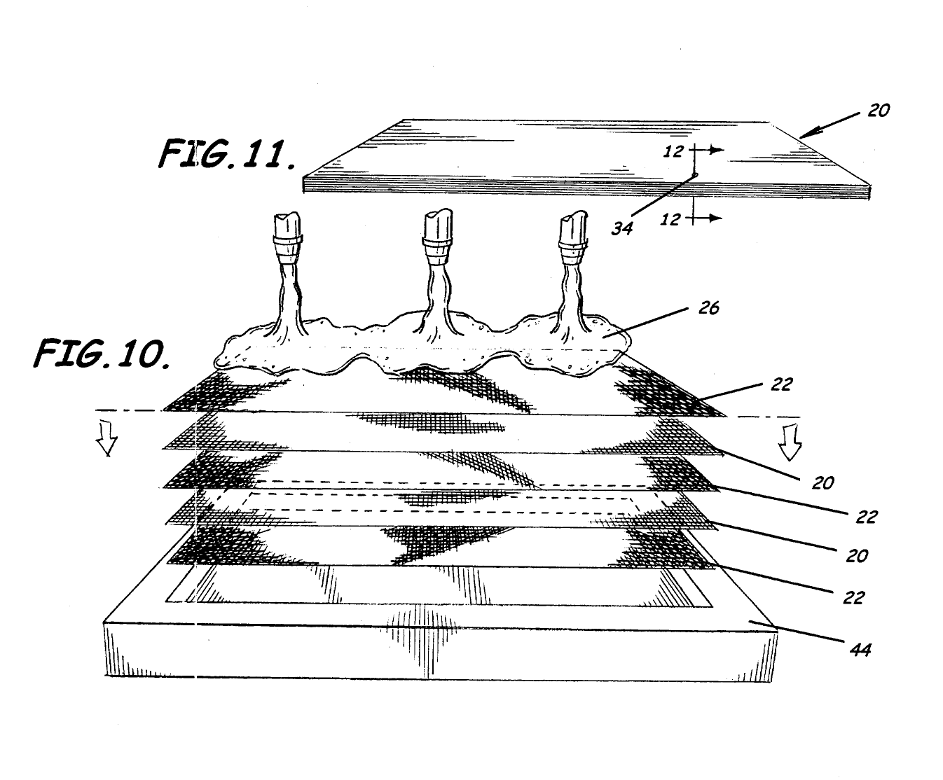

As shown in FIGS. 1-15, the present invention provides a laminate preferably formed in sheets for various applications. Such applications, for example, include boats, trucking floors, recreational vehicles floors and side walls, housing, cabinets, ice arenas, agricultural building floors, reusable concrete forms, appliances and many other applications where high bonding strength and fastener retention can be important. The laminate is preferably formed in sheets or boards and preferably has a fibrous material, a strengthening material such as glass, and natural fiber material (pure, filled, or recycled). The laminate is preferably formed of recycled polyolefins having fillers, such as ground glass, natural fibers, shredded cloth, polypropylene, scrap urethane, or other materials that are heated, mixed, and made into a high viscosity gelatin mass 25, e.g., between about 300° F. to about 425° F., as shown in FIG. 1. The recycled polyolefin is combined with a fibrous material in the form of a veil of some type such as Trevira (or other synthetic material), glass (such as fiberglass or other mineral origin materials), or natural fibers or combinations thereof.

In view of the foregoing, the present invention advantageously provides a fastener retention laminate sheet 20 and associated methods of forming the laminate sheet 20 that substantially enhance the fastener retention properties of the laminate sheet 20. The present invention can be used in forming a fastener retention laminate foamed sheet 40 that substantially enhances the strength and fastener retention properties of the laminate foamed sheet 40. The sheets and associated methods readily allow laminate sheets to be formed for use in boats, trucking floors, recreational vehicles, housing, cabinets, ice arenas, agricultural building floors, reusable concrete forms, appliances and many other applications where high bonding strength and fastener retention can be important. The laminate sheets and associated methods of forming the laminate sheets described herein are cost effective to produce and relatively simple to manufacture.

The laminate sheets of the present invention advantageously enhance the retainment of fasteners when inserted into the laminate sheets and provide a superior bonding surface. In all embodiments of the current invention, the laminate sheets, the laminate foamed sheets, and combinations of sheets and threaded fasteners have high strength and enhanced fastener retention properties so that a threaded fastener 34 is retained within a sheet and is not easily removed when an outward force is applied thereto.

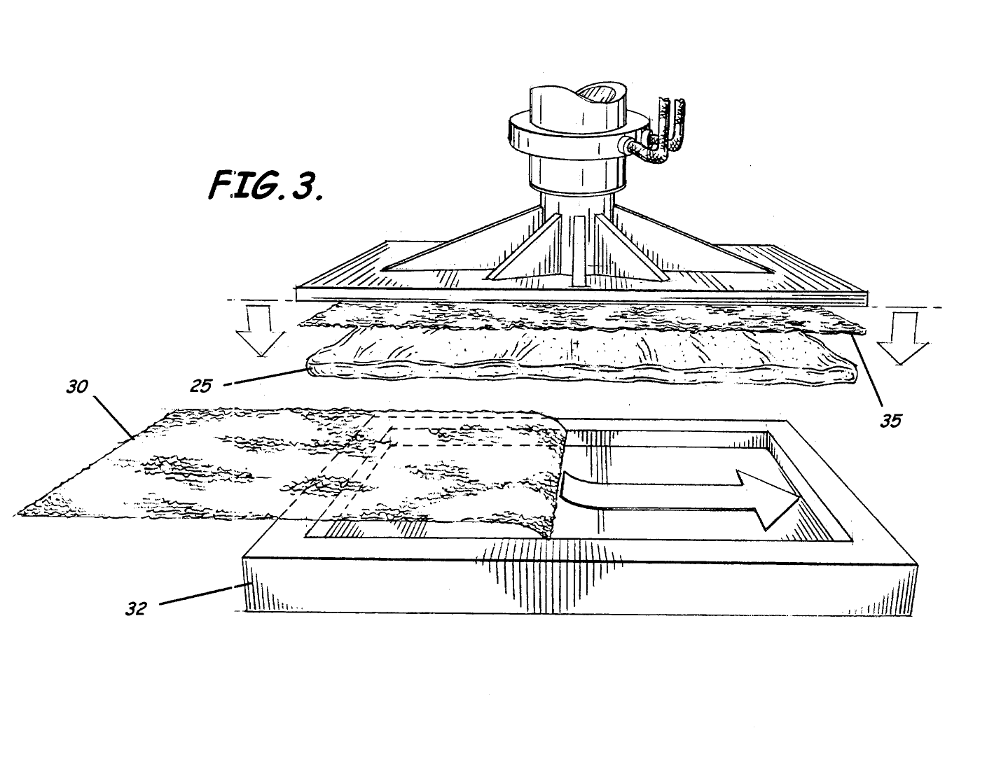

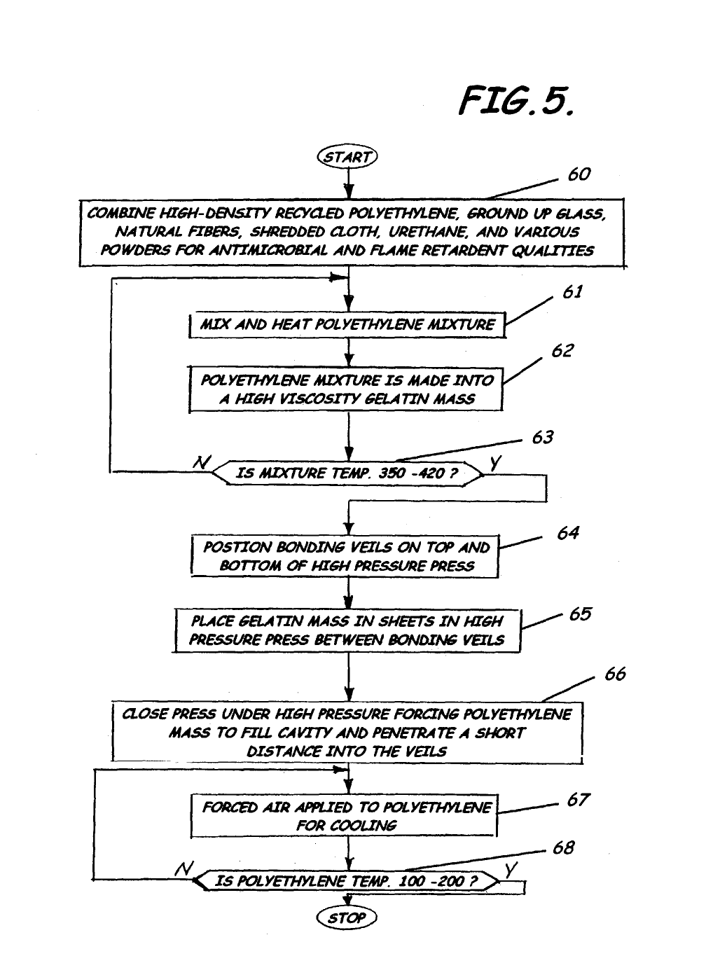

One embodiment of the present invention preferably provides a method of forming a laminate sheet 20, which is shown in FIG. 5. To form the laminate sheet 20, a polyolefin blend 15 is first heated, preferably to a temperature in the range of about 300° F. to about 425° F., thereby resulting in a gelatin mass 25, as shown in FIGS. 1 and 2 (blocks 60-63). As illustrated in FIG. 3, a first bonding veil 30 is positioned in a high pressure press 32, followed by the gelatin mass 25, and then a second bonding veil 35 (blocks 64-65). The first and second bonding veils can be a fibrous material in the form of a veil of some type such as Trevira (or other synthetic material), glass (such as fiberglass or other mineral origin materials), or natural fibers or combinations thereof. Other preferable types of bonding veils 30, 35 can include a synthetic material, a glass material, urethane, natural fibers and combinations thereof. Once the materials are in the press 32, the press 32 is closed and the gelatin mass 25 is compressed between the first and second bonding veils 30, 35 to imbed the gelatin mass 25 within the first and second bonding veils 30, 35 (block 66). When this occurs, the first and second bonding veils 30, 35 abuttingly contact and substantially adhere to the gelatin mass 25. The high pressure within the press 32 forces the gelatin mass 25 to fill the press cavity and penetrate a short distance into the first and second bonding veils 30, 35.

The gelatin mass 25 is typically not adhesive, but the instant melting method enables it to adhere to materials in which it normally would not adhere. The bonding veils 30, 35 are mechanically bonded to the surface of the polyolefin. The mechanical bonding of the veils to the polyolefin enables the bonding veils 30, 35 to adhere to polyolefin.

The laminate sheet 20 can also be formed by adding at least one layer of a urethane material in the press 32 before compressing the gelatin mass 25 between the first and second bonding veils 30, 35. The urethane material can be used as one of the bonding veils 30, 35, also. The urethane can adhere to one or both sides of the first and second bonding veils 30, 35.

A laminate sheet 20 capable of being used as a moisture barrier in walls of buildings can be constructed by using a construction grade polyolefin film bonded to a bonding veil 30 when the film is just above, at or slightly below its melt temperature. The polyolefin film can be produced by a single screw extruder with an extrusion die. The polyolefin film has a preferred film thickness in a range of about 0.8 mil 1.4 mil thickness. The finished laminate sheet 20 can be fastened to a wooden or aluminum wall by methods known by those skilled in the art. The non-woven bonding veil 30 allows other desired materials to be sprayed upon its surface, such as a fire-retardant material or a foam material for increased insulation with or without an outer coating of stucco.

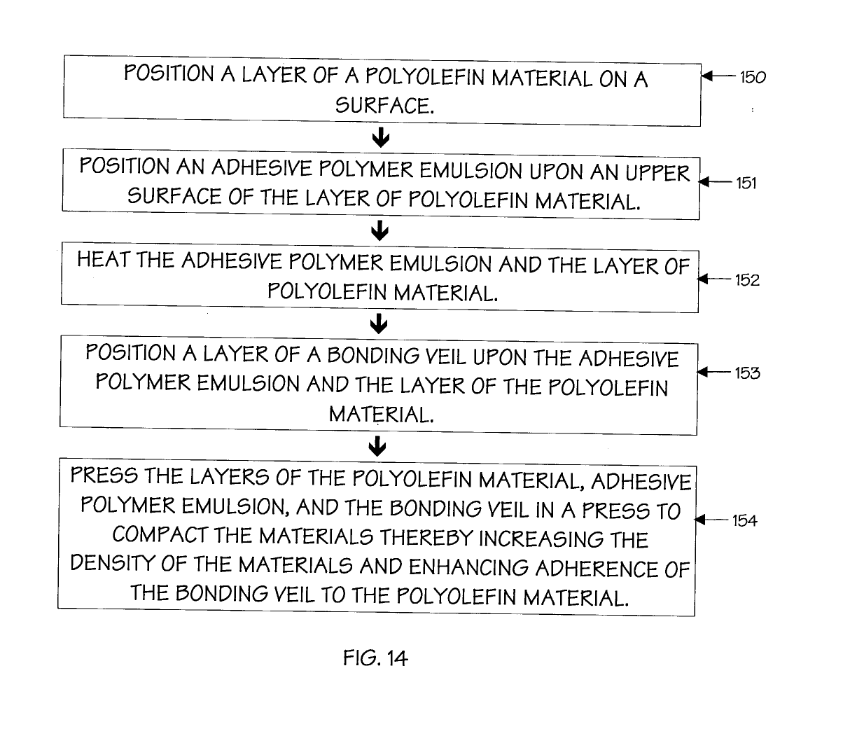

A rigid or a semi-rigid or flexible recycled polyolefin composite can be used to form the laminate sheet 20 of the present invention. The semi-rigid or flexible recycled polyolefin composite can be in the form of a roll of material. The bonding veil 30 can also be in the form of a roll of material. If the polyolefin and the bonding veil are both in a roll form, the laminate sheet 20 can be formed by positioning the polyolefin material onto a surface as described in FIG. 14 (block 150). An adhesive polymer emulsion is sprayed upon an upper surface of the polyolefin material (block 151). The adhesive polymer emulsion preferably contains water and a polymer. The polyolefin material with the adhesive polymer emulsion is then exposed to a radiant heat source, such as a microwave heat source, to melt the surface of the polyolefin material (block 152). Immediately thereafter, the bonding veil is positioned to overly the polyolefin material and adhesive polymer emulsion (block 153). The layers of material are then passed through a press to bond the bonding veil to the polyolefin material (block 154). The press can be two pressure rolls or any suitable press for pressing the two materials as will be known to those skilled in the related art. Exposing the polyolefin material and the adhesive polymer emulsion to the heat source results in a quick temperature rise of the water in the polymer emulsion. The water in the adhesive polymer emulsion simultaneously melts the polymer in the emulsion and the surface of the polyolefin material. The duration of the heating process (block 152) is only a matter of seconds to prevent melting the bulk of the polyolefin material.

As another alternative, the laminate sheet 20 can also be formed by adding at least one layer of a glass material in the press before compressing the gelatin mass 25 between the first and second bonding veils 30, 35. The glass material can be used as one of the bonding veils 30, 35, also. The glass can adhere to one or both sides of the first and second bonding veils 30, 35.

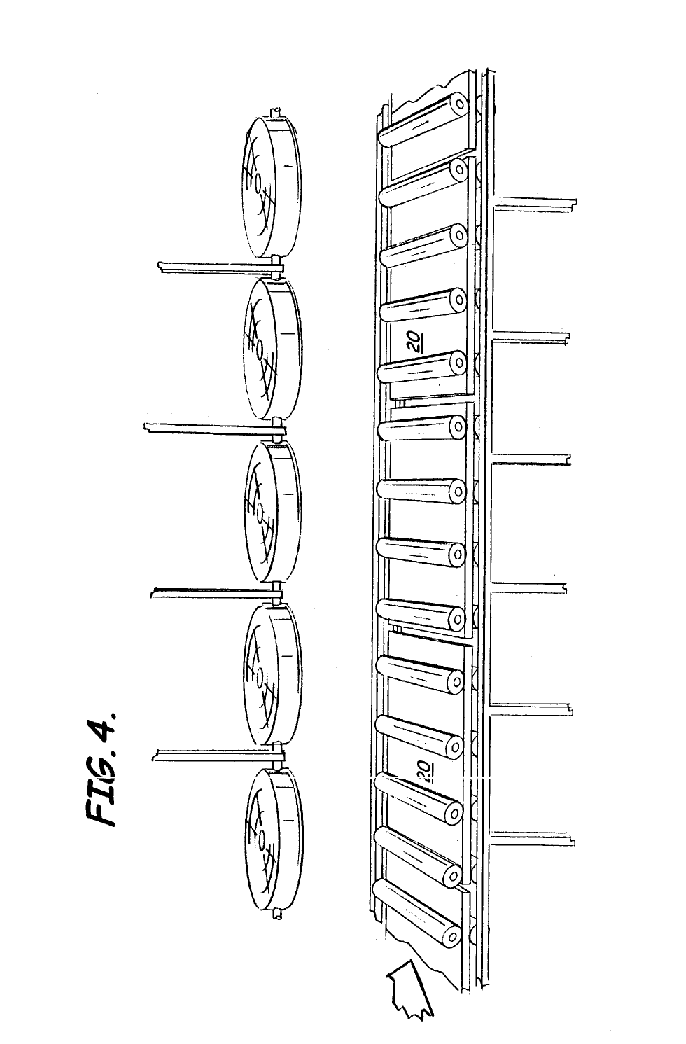

Once the laminate sheets 20 are formed, the sheets 20 can be cooled for further use, as demonstrated in FIG. 4 (block 67 of FIG. 5). One such use is as a component in a laminate foamed sheet 40.

The laminate sheet 20 of the present invention can be used to form other types of sheets. For example, a method of forming a laminate foamed sheet 40 using the laminate sheet 20 of the present invention. Adding a laminate sheet 20 to a laminated foamed sheet will increase the bonding strength of the foamed sheet and increase such properties as screw retention and strength.

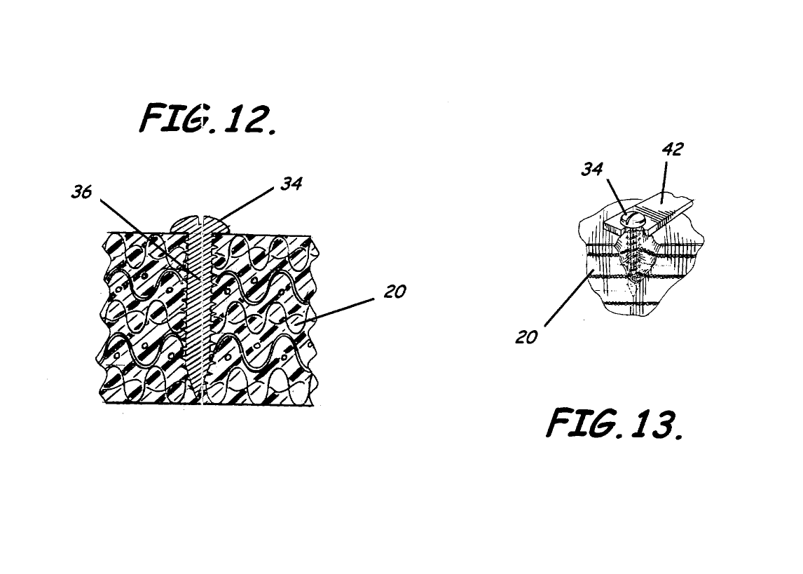

A method of retaining a threaded fastener 34 within a laminate sheet 20 is advantageously provided as another embodiment of the current invention. In this embodiment, the method preferably includes providing a laminate sheet 20 having a density in the range of about 35 pounds per cubic foot to about 65 pounds per cubic foot and positioning a threaded fastener 34 therein. The laminate sheet 20 can have a density in the range of about 40 pounds per cubic foot to 63 pounds per cubic foot. The threaded fastener 34 is advantageously retained within the laminate sheet 20 and is not easily removed when an outward force is applied, as shown in FIG. 12. The laminate sheet 20 can include a polyolefin blend 15 and a bonding veil 30, 35. The bonding veil 30, 35 contacts and substantially adheres to the polyolefin blend, as described herein.

Another embodiment of the present invention includes a combination comprising a laminate sheet 20, a threaded fastener 34, and a layer of material 42 between an outer surface of the laminate sheet 20 and the threaded fastener 34, as depicted in FIG. 13. The threaded fastener 34 is not easily removed from the laminate sheet 20 and layer of material 42. It is envisioned that the fastener 34 will be secured to the laminate sheet 20, as well as, the overlying layer of material 42. The fastener 34 can also be secured to a surface below the laminate sheet 20 (not shown), thereby securing the laminate sheet 20 and the overlying material 42 to the lower surface. This embodiment can be used in various installations, such as to secure flooring to a laminate sheet 20 or add metallic strips to vehicles. Other applications of this embodiment will be known to those skilled in the art and are to be considered within the scope of the present invention.

The present invention further advantageously provides a method of retaining enhanced fastener retention properties in a laminate sheet 20. The method includes providing a laminate sheet 20 that preferably includes a polyolefin blend 15 and a bonding veil 30, 35. A threaded fastener 34 is then twisted into the laminate sheet 20, so that the fastener 34 becomes engaged within the laminate sheet 20. The threaded fastener 34 is then removed from the laminate sheet 20. The laminate sheet 20 retains its enhanced fastener retention properties once the threaded fastener 34 is removed. The laminate sheet 20 retains its enhanced fastener retention properties even if this method is performed repeatedly upon the laminate sheet 20.

In addition to the method embodiments of the present invention, several other embodiments are also included. These embodiments include laminate sheets and combination fastener and laminate sheets. The laminate sheet final product of the current invention has a high density, preferably in the range of about 35 lb/ft3 to about 65 lb/ft3, and more preferably in the range of about 40 lb/ft3 to about 63 lb/ft3. The laminate sheets are formed in various sizes and thicknesses.

The present invention advantageously provides a laminate sheet 20 as one embodiment shown in FIG. 11 and also a combination fastener 34 and laminate sheet 20 as another embodiment shown in FIG. 12. The combination preferably includes a laminate sheet 20 and a fastener 34 having threaded portions positioned within the laminate sheet 20 so that the threaded portions are retained in the laminate sheet. The laminate sheet 20 preferably includes a polyolefin blend and a bonding veil. The bonding veil preferably contacts and substantially adheres to the polyolefin blend. When constructed in this manner, the threaded fastener 34 is not easily removed when an outward force is applied thereto.

Another laminate sheet 20 embodiment and another combination fastener 34 and laminate sheet 20 embodiment are also both included as further embodiments of the present invention. In the combination embodiment, the combination preferably comprises a laminate sheet 20 having a polyolefin blend 15, a glass material 22, and a bonding veil 30, 35. In both embodiments, the laminate sheet 20 preferably has a density in the range of about 35 pounds per cubic foot to about 65 pounds per cubic foot. The laminate sheet 20 more preferably has a density in the range of about 40 pounds per cubic foot to about 63 pounds per cubic foot. The bonding veil 30, 35 contacts and substantially adheres to the polyolefin blend 15 and the glass material 22.

The polyolefin blend 15 used in many of the embodiments preferably includes a polyolefin and a filler. The filler can contain one or more of the following components: glass, natural fibers, shredded cloth, urethane, colorants, various powders for antimicrobial and flame retardant properties, and combinations thereof.

In all embodiments of the present invention that use a polyolefin, the polyolefin is preferably polyethylene, polypropylene, or any other suitable polyolefin. Such suitable alternate polyolefin will be known to those skilled in the art. One particularly effective polyolefin is a recycled polyethylene that includes a reground, scrap polyethylene with at least one filler, such as ground up glass, shredded cloth, polyethylene, scrap urethane with glass, scrap urethane without glass, natural fibers and combinations thereof. The scrap polyethylene and fillers are formed into sheets of various sizes and thickness. The recycled polyethylene possesses many properties that make it a particularly effective polyolefin for use in this invention. The scrap polyethylene and the fillers increase the retention properties of the laminate sheets 20 and laminate foamed sheets 40 made from the recycled polyethylene. Laminate sheets 20 and laminate foams sheets 40 containing this recycled polyethylene can be used in applications where high bonding strength and screw retention are desired properties. The glass and resins in boat building bond particularly well to the recycled polyethylene because of the bonding veil 30, 35 on the surface of the polyethylene. The bonding veils 30, 35 also allow the recycled polyethylene sheet to bond to high density glass filled urethane sheets, such as those produced by Penske Plastics Composites, Inc., 490 Industrial Drive, Mt. Juliet, Tenn. 37122.

Post-industrial and post consumer recycled plastics and cellulose are preferably used to manufacture the recycled polyolefin composite of the present invention. A high-intensity processor is typically used to process the recycled polyolefin composite. The high-intensity processor uses an extremely high-intensity mixing, or shearing, action to rapidly transfer mechanical energy into heat to produce a wide variety of materials. The processor rapidly transforms powder, pellets, chips, and regrind material into a consistent, homogeneous charge for subsequent processing. The shearing action causes the material to soften and melt quickly at relatively low temperatures. After processing, the material emerges from the processor as a molten mass, ready for conversion by extrusion or molding into continuous or individually formed products. The composite output from the processor is molded into the end product by a press or the output from the processor can also feed the extruder that goes through a sheet die and rollers to produce a continuous sheet. The composite can be formed into a roll of recycled polyolefin composite, as described herein.

The amounts of fillers used to produce the recycled polyolefin composite can be varied. For example, the following composition for a ridged polyolefin composite that is effective for use as described herein with a bonding veil, glass mat, polyurethane, polyester, and natural long fiber blends:

| Wt. % | Component |
|---|---|
| 40 | Recycled polyethylene/polypropylene melt flows |
| | 2-20 grams/10 min. |
| 25 | Regrind of polyolefin composite mix design |
| 10 | Polypropylene fiber material melt flows 20-50 grams/10 min. |
| 15 | Cellulose fibers (saw dust, flax, kenaf, coffee, or |
| | combinations thereof) |
| 5 | Low density polyethylene |
| 3 | Calcium hydroxide, calcium carbonate, or other mineral fillers |
| 2 | Bonding additives, such as FUSABOND ® resin MB226D |

The term melt flows refers to the amount of material in grams that flows in a ten-minute time period. A test to determine this measurement can be found in ASTM D 1238 (Procedure A). Regrind of polyolefin composite mix design refers to materials that have been ground from prior constructed finished product laminate boards made in accordance with the present invention. FUSABOND® resin MB226D is manufactured by Dupont Chemical Company. FUSABOND® includes a maleic anhydride grafted polyolefin resins including polyethylene, polypropylene, ethylene propylene diene monomer (EPDM), ethylene vinyl acetate (EVA) and specialty ethylene copolymers.

Another effective composition for a recycled polyolefin composite is as follows:

| Wt. % | Component |
|---|---|
| 40 | Recycled polyethylene/polypropylene melt flows |
| | 2-20 grams/10 liters |
| 20 | Recycled polyethylene/polypropylene/other polyolefins melt |
| | flows 20-50 grams/liter |
| 35 | Cellulose fibers, glass fibers, urethane regrind with glass or |
| | without glass, decaffeinated coffee grounds, cellulose, rubber |
| | crumb, mineral fillers, ground cloth, leather, or combinations |
| | thereof |
| 3 | Calcium hydroxide, flame retardants, antimicrobial agents |

As an alternate to the polyolefin in all embodiments, another non-adhesive material can be used, such as plastics, resins, a glass material, and combinations thereof. The polyolefin or the non-adhesive material is combined with a fibrous material in the form of a veil of some type such as Trevira (or other synthetic material), glass (such as fiberglass or other mineral origin materials), natural fibers, or combinations thereof.

Many modifications and other embodiments of the invention will come to the mind of one skilled in the art having the benefit of the teachings presented in the foregoing descriptions and the associated drawings.

As an advantage of the present invention, the composite materials can be customized to suit any combination of strength, size, weight, and durability specifications. As an advantage of this invention, the new laminate sheets will enable users to securely fasten materials to a laminate sheet 20 alone or to an underlying surface behind the laminate sheet 20. The laminate sheet 20 can be used below an overlying material, such as for padding for flooring, or the laminate sheet 20 can be added on top of an underlying surface, such as for installing handles on car doors. The improved fastener retention properties of the laminate sheet 20 will allow thicker layers of the laminate sheet 20 to be used. As another advantage of the present invention, threaded fasteners 34 will securely remain in the laminate and laminate foamed sheets 40 when the fastener 34 has a forced applied to it. Repeated insertion and removal of the threaded fastener 34 will not affect the fastener retention properties of the laminate sheet 20. This will allow laminate and laminate foamed sheets 20, 40 to last longer, since the threaded fasteners 34 will not destroy the sheets 20, 40 in the area that abuttingly contacts the threaded fasteners 34, as which occurs with current laminate sheets.

As another advantage, the methods of forming the laminate sheets 20 of the present invention enable typically non-adhesive materials, such as polyolefins, to adhere to materials that they normally would not adhere. This is particularly advantageous since these materials have high strength and great fastener retention properties. The use of the recycled polyethylene certainly has many advantages to its use. Disposal costs and associated environmental problems will be significantly reduced by recycling spent polyolefins for reuse as a raw material in the laminate sheets of the present invention. Raw material costs will be lower by using recycled polyolefins.

As another advantage, the recycled laminate sheet made in accordance with the present invention performs exceptionally well in replacing plywood in the marine manufacturing industry, which has used plywood for many years. The laminate sheets of the present invention will not rot due to exposure to water, will not absorb water thereby preventing any weight gain, will not delaminate, or grow fungus. The laminate sheets have around twice the bonding strength and screw retention properties as plywood. In a typical marine industry installation, the laminate sheet is placed on or between fiberglass structures. These types of installations require high strength, compression, bondability, and screw retention for such boat items as seats, windless anchors, trim tabs, gumwale blocks, wire harnesses, live well boxes, stringers, and other areas throughout the boat.

Therefore, it is to be understood that the invention is not to be limited to the specific embodiments disclosed, and that modifications and embodiments are intended to be included within the scope of the specification.

That claimed is:

1. A method of forming a laminate sheet having high strength and enhanced fastener retention so that a threaded fastener is retained within the laminate sheet and is not easily removed from the laminate sheet when an outward force is applied thereto, the method comprising:
heating a polyolefin blend resulting in a gelatin mass;
positioning a first bonding veil in a press;
positioning the gelatin mass in the press;
positioning a second bonding veil in the press; and
compressing the gelatin mass between the first and second bonding veils within the press to imbed the gelatin mass within the first and second bonding veils so that the first and second bonding veils abuttingly contact and substantially adhere to the gelatin mass and so that the gelatin mass fills the press and penetrates a short distance into the first and second bonding veils.

2. A method as defined in claim 1, further comprising cooling the laminate sheet, and wherein the step of heating the polyolefin blend includes heating the polyolefin blend to a temperature in the range of about 300° F. to about 425° F.

3. A method as defined in claim 1, wherein the step of heating the polyolefin blend includes utilizing a polyolefin selected from the group consisting of polyethylene and polypropylene and other polyolefin groups and combinations thereof.

4. A method as defined in claim 3, wherein the laminate sheet has a density in the range of about 35 pounds per cubic foot to about 65 pounds per cubic foot.

5. A method as defined in claim 4, wherein the laminate sheet has a density in the range of about 40 pounds per cubic foot to about 63 pounds per cubic foot.

6. A method as defined in claim 1, wherein the steps of positioning a first and a second bonding veil include utilizing a bonding veil selected from the group consisting of a synthetic material, a glass material, urethane, natural fibers, and combinations thereof.

7. A method as defined in claim 1, wherein the step of heating a polyolefin blend includes utilizing a polyolefin blend comprising a polyolefin and a filler selected from the group consisting of glass, natural fibers, shredded cloth, urethane, various powders for antimicrobial and flame retardant properties, and combinations thereof.

8. A method as defined in claim 7, wherein the step of heating a polyolefin blend includes utilizing a polyolefin comprising a high density, recycled polyethylene, the high density being in the range of about 50 pounds per cubic foot to about 55 pounds per cubic foot, and the recycled polyethylene comprising a scrap polyethylene and at least one filled selected from the group consisting of glass, shredded cloth, polypropylene, scrap urethane with glass, scrap urethane without glass, and combinations thereof.

9. A method as defined in claim 1, further comprising positioning at least one layer of a urethane material in the press before compressing the gelatin mass between the first and second bonding veils.

10. A method as defined in claim 1, further comprising positioning at least one layer of a glass material in the press before compressing the gelatin mass between the first and second bonding veils.

11. A method of forming a laminate sheet having high strength and enhanced fastener retention so that a threaded fastener is retained within the laminate sheet and is not easily removed from the laminate sheet when an outward force is applied thereto, the method comprising:
positioning a layer of a polyolefin material on a surface;
overlying and positioning an adhesive polymer emulsion upon an upper surface of the layer of polyolefin material;
heating the adhesive polymer emulsion and the layer of polyolefin material to thereby form a heated adhesive polymer emulsion;
positioning a layer of a bonding veil upon the heated adhesive polymer emulsion; and
pressing the layers of the polyolefin material and the bonding veil in a press so that the materials are compacted to thereby increase the density of the materials and to enhance adherence of the bonding veil to the polyolefin material.

12. A method of retaining a threaded fastener within a laminate sheet having high strength and enhanced fastener retention, the method comprising the steps of:
providing a laminate sheet having a density in the range of about 35 pounds per cubic foot to about 65 pounds per cubic foot; and
positioning the threaded fastener therein so that the threaded fastener is retained within the laminate sheet and is not easily removed when an outward force is applied.

13. A method as defined in claim 12, wherein the step of providing a laminate sheet having a density in the range of about 35 pounds per cubic foot to about 65 pounds per cubic foot includes utilizing a laminate sheet having a density in the range of about 40 pounds per cubic foot to about 63 pounds per cubic foot.

14. A method as defined in claim 12, further comprising positioning another layer of material between the laminate sheet and the threaded fastener.

15. A method as defined in claim 12, wherein the step of providing a laminate sheet includes utilizing a laminate sheet comprising a polyolefin blend and a bonding veil, the bonding veil contacting and substantially adhering to the polyolefin blend.

16. A method as defined in claim 15, wherein the step of utilizing a laminate sheet comprising a polyolefin blend includes utilizing a polyolefin blend comprising a polyolefin and a filler selected from the group consisting of glass, natural fibers, shredded cloth, urethane, various powders for antimicrobial and flame retardant properties, and combinations thereof.

17. A method as defined in claim 15, wherein the step of providing a laminate sheet includes utilizing a laminate sheet comprising a polyolefin, the polyolefin comprising a high density, recycled polypropylene, wherein the high density is in the range of about 50 pounds per cubic foot to about 55 pounds per cubic foot, and the recycled polypropylene comprising a scrap polyethylene and at least one filled selected from the group consisting of glass, shredded cloth, polypropylene, scrap urethane with glass, scrap urethane without glass, and combinations thereof.

18. A method as defined in claim 12, further comprising twisting the threaded fastener within a location so that the threaded fastener remains tightened when an outward force is applied.

19. A method of retaining enhanced fastener retention properties in a laminate sheet comprising the steps of:
providing a laminate sheet, the laminate sheet comprising a polyolefin blend and a bonding veil;
twisting a threaded fastener into the laminate sheet, so that the fastener becomes engaged within the laminate sheet; and
removing the threaded fastener from the laminate sheet so that the laminate sheet retains its enhanced fastener retention properties.

20. A method of forming a laminate sheet having high strength and enhanced fastener retention so that a threaded fastener is retained within the laminate sheet and is not easily removed from the laminate sheet when an outward force is applied thereto, the method comprising:
heating a non-adhesive material resulting in a melted non-adhesive material;
positioning a first bonding veil in a press;
positioning the melted non-adhesive material in the press;
positioning a second bonding veil in the press; and
compressing the melted non-adhesive material between the first and second bonding veils within the press to imbed the melted non-adhesive material within the first and second bonding veils so that the first and second bonding veils abuttingly contact and substantially adhere to the melted non-adhesive material.

21. A method as defined in claim 20, further comprising cooling the laminate sheet, and wherein heating a non-adhesive material includes utilizing a non-adhesive material selected from the group consisting of plastics, resins, a glass material, and combinations thereof.

22. A method of retaining a threaded fastener within a laminate sheet having high strength and enhanced fastener retention, the method comprising the steps of:
providing a laminate sheet having a density in the range of about 35 pounds per cubic foot to about 65 pounds per cubic foot, the laminate sheet comprising a non-adhesive material and a bonding veil, the bonding veil contacting and substantially adhering to the non-adhesive material; and
positioning a threaded fastener therein so that the threaded fastener is retained within the laminate sheet and is not easily removed when an outward force is applied.

23. A method as defined in claim 22, wherein the step of providing a laminate sheet having a density in the range of about 35 pounds per cubic foot to about 65 pounds per cubic foot includes utilizing a laminate sheet having a density in the range of about 40 pounds per cubic foot to about 63 pounds per cubic foot.

24. A method as defined in claim 22, wherein the step of providing a laminate sheet comprising a non-adhesive material includes utilizing a non-adhesive material selected from the group consisting of plastics, resins, a glass material, and combinations thereof.

25. A method as defined in claim 22, further comprising positioning another layer of material between the laminate sheet and the threaded fastener.

26. A combination fastener and laminate sheet having high strength and enhanced fastener retention so that the fastener is not easily removed from the laminate sheet when an outward force is applied thereto, the combination comprising:
a laminate sheet having a polyolefin blend and a bonding veil, the bonding veil contacting and substantially adhering to the polyolefin blend; and
a fastener having threaded portions positioned within the laminate sheet so that the threaded portions are retained in the laminate sheet and are not easily removed when an outward force is applied thereto.

27. A combination as defined in claim 26, wherein the polyolefin blend comprises a polyolefin and a filler selected from the group consisting of glass, natural fibers, shredded cloth, urethane, various powders for antimicrobial and flame retardant properties, and combinations thereof.

28. A combination as defined in claim 27, wherein the polyolefin comprises a high density, recycled polyethylene, wherein the high density is in the range of about 50 pounds per cubic foot to about 55 pounds per cubic foot, and the recycled polyethylene comprising a scrap polyethylene and at least one filled selected from the group consisting of glass, shredded cloth, polypropylene, scrap urethane with glass, scrap urethane without glass, and combinations thereof.

29. A combination as defined in claim 28, wherein the laminate sheet has a density in the range of about 35 pounds per cubic foot to about 65 pounds per cubic foot.

30. A combination as defined in claim 27, wherein the laminate sheet has a density in the range of about 40 pounds per cubic foot to about 63 pounds per cubic foot.

31. A combination as defined in claim 27, wherein the polyolefin is selected from the group consisting of polyethylene and polypropylene.

32. A combination as defined in claim 27, wherein the laminate sheet further comprises a glass material, the bonding veil contacting and substantially adhering to the polyolefin blend and the glass material.

33. A combination as defined in claim 27, wherein the laminate sheet further comprises a urethane material, the bonding veil contacting and substantially adhering to the polyolefin blend and the urethane material.

34. A combination as defined in claim 27, further including a layer of material between an outer surface of the laminate sheet and the fastener, wherein the fastener is not easily removed from the layer of material.

35. A laminate sheet having high strength and enhanced fastener retention so that when a fastener, having threaded portions, is positioned within the laminate sheet, the fastener is not easily removed from the laminate sheet when an outward force is applied thereto, the laminate sheet comprising: a polyolefin blend and a bonding veil, the bonding veil contacting and substantially adhering to the polyolefin blend.

36. A laminate sheet as defined in claim 35, wherein the polyolefin blend comprises a polyolefin and a filler selected from the group consisting of glass, natural fibers, shredded cloth, urethane, various powders for antimicrobial and flame retardant properties, and combinations thereof.

37. A laminate sheet as defined in claim 36, wherein the polyolefin comprises a high density, recycled polyethylene, wherein the high density is in the range of about 50 pounds per cubic foot to about 55 pounds per cubic foot, and the recycled polyethylene comprising a scrap polyethylene and at least one filled selected from the group consisting of glass, shredded cloth, polypropylene, scrap urethane with glass, scrap urethane without glass, and combinations thereof.

38. A laminate sheet as defined in claim 36, wherein the laminate sheet has a density in the range of about 35 pounds per cubic foot to about 65 pounds per cubic foot.

39. A laminate sheet as defined in claim 38, wherein the laminate sheet has a density in the range of about 40 pounds per cubic foot to about 63 pounds per cubic foot.

40. A laminate sheet as defined in claim 36, wherein the polyolefin is selected from the group consisting of polyethylene and polypropylene.

41. A laminate sheet as defined in claim 36, further comprising a glass material, the bonding veil contacting and substantially adhering to the polyolefin blend and the glass material.

42. A laminate sheet as defined in claim 36, further comprising a urethane material, the bonding veil contacting and substantially adhering to the polyolefin blend and the urethane material.

43. A combination fastener and laminate sheet having high strength and enhanced fastener retention so that the fastener is not easily removed from the laminate sheet when an outward force is applied thereto, the combination comprising:
a laminate sheet having a polyolefin blend, a glass material, and a bonding veil, the laminate sheet having a density in the range of about 35 pounds per cubic foot to about 65 pounds per cubic foot, the bonding veil contacting and substantially adhering to the polyolefin blend and the glass material; and
a fastener having threaded portions positioned within the laminate sheet so that the threaded portions are retained in the laminate sheet and are not easily removed when an outward force is applied thereto.

44. A combination as defined in claim 43, wherein the laminate sheet has a density in the range of about 40 pounds per cubic foot to about 63 pounds per cubic foot.

45. A combination as defined in claim 43, wherein the polyolefin blend comprises a polyolefin and a filler selected from the group consisting of glass, natural fibers, shredded cloth, urethane, various powders for antimicrobial and flame retardant properties, and combinations thereof.

46. A combination as defined in claim 43, wherein the polyolefin blend comprises a high density, recycled polyethylene, wherein the high density is in the range of about 50 pounds per cubic foot to about 55 pounds per cubic foot, and the recycled polyethylene comprising a scrap polyethylene and at least one filled selected from the group consisting of glass, shredded cloth, polypropylene, scrap urethane with glass, scrap urethane without glass, natural fibers, and combinations thereof.

47. A combination as defined in claim 43, further including a layer of material between an outer surface of the laminate sheet and the fastener, wherein the fastener is not easily removed from the layer of material.

48. A combination as defined in claim 43, wherein the laminate sheet further includes a layer of urethane material, the bonding veil contacting and substantially adhering to the polyolefin blend, the glass material, and the urethane material.

49. A laminate sheet having high strength and enhanced fastener retention so that when a fastener, having threaded portions, is positioned within the laminate sheet, the fastener is not easily removed from the laminate sheet when an outward force is applied thereto, the laminate sheet having a density in the range of about 35 pounds per cubic foot to about 65 pounds per cubic foot, the laminate sheet comprising: a polyolefin blend, a glass material, and a bonding veil, the bonding veil contacting and substantially adhering to the polyolefin blend and the glass material.

50. A laminate sheet as defined in claim 49, wherein the laminate sheet has a density in the range of about 40 pounds per cubic foot to about 43 pounds per cubic foot.

51. A laminate sheet as defined in claim 49, wherein the polyolefin blend comprises a polyolefin and a filler selected from the group consisting of glass, natural fibers, shredded cloth, urethane, various powders for antimicrobial and flame retardant properties, and combinations thereof.

52. A laminate sheet as defined in claim 49, wherein the polyolefin blend comprises a high density, recycled polyethylene, wherein the high density is in the range of about 50 pounds per cubic foot to about 55 pounds per cubic foot, and the recycled polyethylene comprising a scrap polyethylene and at least one filled selected from the group consisting of glass, shredded cloth, polypropylene, scrap urethane with glass, scrap urethane without glass, natural fibers, and combinations thereof.

53. A laminate sheet having high strength and enhanced fastener retention so that when a fastener, having threaded portions, is positioned with the laminate sheet, the fastener is not easily removed from the laminate sheet when an outward force is applied thereto, the laminate sheet comprising: a bonding veil and a non-adhesive material, the bonding veil contacting and substantially adhering to the non-adhesive material.

54. A laminate sheet as defined in claim 53, wherein the non-adhesive material is selected from the group consisting of plastics, resins, a glass material, and combinations thereof.

55. A combination fastener and laminate sheet having high strength and enhanced fastener retention so that the fastener is not easily removed from the laminate sheet when an outward force is applied thereto, the combination comprising:
a laminate sheet having a non-adhesive material and a bonding veil, the bonding veil contacting and substantially adhering to the non-adhesive material; and
a fastener having threaded portions positioned within the laminate sheet so that the threaded portions are retained in the laminate sheet and are not easily removed when an outward force is applied thereto.

56. A combination as defined in claim 55, wherein the non-adhesive material is selected from the group consisting of plastics, resins, a glass material, and combinations thereof.
